(19) United States
(12) Patent Application Publication
(10) Pub. No.: US 2014/0065379 A1
(43) Pub. Date: Mar. 6, 2014

(54) TOPCOAT SURFACES FOR DIRECTING THE ASSEMBLY OF BLOCK COPOLYMER FILMS ON CHEMICALLY PATTERNED SURFACES

(71) Applicants: Paul Franklin Nealey, Madison, WI (US); Hyo Seon Suh, Madison, WI (US); Jeong In Lee, Madison, WI (US)

(72) Inventors: Paul Franklin Nealey, Madison, WI (US); Hyo Seon Suh, Madison, WI (US); Jeong In Lee, Madison, WI (US)

(73) Assignee: WISCONSIN ALUMNI RESEARCH FOUNDATION, Madison, WI (US)

(21) Appl. No.: 13/601,460

(22) Filed: Aug. 31, 2012

(51) Int. Cl. B32B 37/24; B32B 3/10

(52) U.S. Cl. 428/195.1; 264/261

(57) ABSTRACT

Provided are novel methods of fabricating block copolymer thin film structures that allow control over both the lateral structure and vertical orientation of the thin films. In some embodiments, the methods involve directing the assembly of a block copolymer thin film between a chemically patterned surface and a second surface such that the thin film includes domains that are oriented perpendicularly through the thickness of the thin film. In certain embodiments, the second surface can be preferential at least one block of the block copolymer. In certain embodiments, the second surface can be a homopolymer. Also provided are thin film block copolymer structures having perpendicular orientations through the thickness of the thin films. The methods and structures may include block copolymers having large interaction parameters (χ's) and small domain sizes.

### BACKGROUND OF THE INVENTION

Advanced nanoscale science and engineering have driven the fabrication of two-dimensional and three-dimensional structures with nanometer precision for various applications including electronics, photonics and biological engineering. Traditional patterning methods such as photolithography and electron beam lithography that have emerged from the microelectronics industry are well suited to fabricate two-dimensional features on ultraflat silicon and glass surfaces. However, building three-dimensional device structures involves repeated photoresist patterning and pattern transfer processes.

### SUMMARY

Provided are novel methods of fabricating block copolymer thin film structures that allow control over both the lateral structure and vertical orientation of the thin films. In some embodiments, the methods involve directing the assembly of a block copolymer thin film between a chemically patterned surface and a second surface such that the thin film includes domains that are oriented perpendicularly through the thickness of the thin film. In certain embodiments, the second surface can be preferential at least one block of the block copolymer. In certain embodiments, the second surface can be a homopolymer. Also provided are thin film block copolymer structures having perpendicular orientations through the thickness of the thin films. The methods and structures may include block copolymers having large interaction parameters (χ's) and small domain sizes.

One aspect described herein relates to method of forming a block copolymer structure. The method can include providing a block copolymer material between a first surface chemically patterned with a pattern and a second surface, with the second surface is preferential to at least one block of the block copolymer material; and directing the assembly of the block copolymer material in accordance with the pattern to form a thin film including microphase-separated block copolymer domains, such that the microphase-separated block copolymer domains are oriented perpendicular to the first and second surfaces throughout the thickness of the thin film. Examples of second surfaces include homopolymers, metals, and dielectric materials. In some embodiments, the pattern has a feature density less than that of the microphase-separated block copolymer domains. For example, the pattern feature density can be 1/n that of the density of microphase-separated block copolymer domains in the thin film, with n an integer equal to or greater than 2. According to various embodiments, the block copolymer material can include a di-block copolymer or higher order block copolymer.

In some embodiments, the block copolymer material is an A-b-B block copolymer, the second surface is C surface, the pattern feature density is 1/n that of the density of microphase-separated block copolymer domains in the thin film, and

$$n < \frac{{γ}_{A - B}}{\vert {γ}_{B - C} - {γ}_{A - C} \vert}$$

with γ_{B-C}, γ_{A-C}, and γ_{A-B} being the interfacial energies of the B-C, A-C and A-B pairs respectively. According to various embodiments, the block copolymer material can have any appropriate bulk morphology, including a lamellar-forming, cylindrical-forming or spherical-forming. Triblock and higher order copolymers having more complex shapes may be used.

Another aspect relates to a method including providing a block copolymer material between a first surface chemically patterned with a pattern and a second surface, the second surface being a homopolymer, a metal or a dielectric material; and directing the assembly of the block copolymer material in accordance with the pattern to form a thin film including microphase-separated block copolymer domains, such that the microphase-separated block copolymer domains are oriented perpendicular to the first and second surfaces throughout the thickness of the thin film.

In some embodiments, the pattern has a feature density less than that of the microphase-separated block copolymer domains. For example, the pattern feature density can be 1/n that of the density of microphase-separated block copolymer domains in the thin film, with n an integer equal to or greater than 2. Diblocks and higher order copolymers having any appropriate bulk morphology can be used.

Another aspect of the description herein is a method including providing a A-b-B block copolymer between a first surface chemically patterned with a pattern and a C second surface; and directing the assembly of the A-b-B block copolymer in accordance with the pattern to form a thin film including microphase-separated block copolymer domains, such that the microphase-separated block copolymer domains are oriented perpendicular to the first and second surfaces throughout the thickness of the thin film, the pattern feature density being 1/n that of the density of microphase-separated block copolymer domains in the thin film, and

$$n < \frac{{γ}_{A - B}}{\vert {γ}_{B - C} - {γ}_{A - C} \vert}$$

with γ_{B-C}, γ_{A-C}, and γ_{A-B} being the interfacial energies of the B-C, A-C and A-B polymers respectively and n is greater than 1. The second surface can be, for example, homopolymer, metal, and a dielectric.

Another aspect of the disclosure is a structure including a block copolymer thin film between a first surface chemically patterned with a pattern and a second surface, with the second surface is preferential to at least one block of the block copolymer thin film, and the thin film including microphase-separated block copolymer domains oriented perpendicular to the first and second surfaces throughout the thickness of the thin film. In some implementations, the second surface is a homopolymer, a metal, or a dielectric. The pattern can have a feature density less than that of the microphase-separated block copolymer domains. In some embodiments, the pattern feature density can be 1/n that of the density of microphase-separated block copolymer domains in the thin film, with n equal to or greater than 2.

Another aspect of the disclosure is a structure including a block copolymer thin film between a first surface chemically patterned with a pattern and a second surface, with the second surface being a homopolymer, a metal or a dielectric material, and the thin film including microphase-separated block copolymer domains oriented perpendicular to the first and second surfaces throughout the thickness of the thin film. The pattern can have a feature density less than that of the microphase-separated block copolymer domains. In some embodiments, the pattern feature density can be 1/n that of the density of microphase-separated block copolymer domains in the thin film, with n equal to or greater than 2.

Another aspect of the disclosure is a structure including a block copolymer thin film between a first surface chemically patterned with a pattern and a second surface, with the thin film including microphase-separated block copolymer domains oriented perpendicular to the first and second surfaces throughout the thickness of the thin film, the microphase-separated block copolymer domains oriented perpendicular to the first and second surfaces throughout the thickness of the thin film, the pattern feature density is 1/n that of the density of microphase-separated block copolymer domains in the thin film, and

$$n < \frac{{γ}_{A - B}}{\vert {γ}_{B - C} - {γ}_{A - C} \vert}$$

with γ_{B-C}, γ_{A-C}, and γ_{A-B} being the interfacial energies of the B-C, A-C and A-B polymers respectively and n is greater than 1. The second surface can be, for example, homopolymer, metal, and a dielectric.

Additional aspects relate to structures, morphologies, and templates formed in the domain structure of block copolymer materials assembled between two condensed phase surfaces.

### BRIEF DESCRIPTION OF THE DRAWINGS

FIG. 1 shows ideal phase behavior of diblock copolymers.

FIG. 2 shows spherical, cylindrical and lamellar ordered copolymer domains formed on substrates.

FIG. 3 provides a cross-sectional schematic illustration of an A/B chemical pattern on a substrate.

FIGS. 4A-4C provide cross-sectional schematic illustrations of A-b-B block copolymer films assembled between an A/B chemical pattern and a surface C.

FIG. 5 shows cross-sectional FE-SEM images of assembled PS-b-P2VP films on PS/P2VP chemical patterns under (a) a PS-r-P2VP mat and (b) a PMMA film.

FIG. 6 provides a cross-sectional schematic illustration of a B-stripe chemical pattern for 3× density multiplication on a substrate.

FIGS. 7A-7E provide cross-sectional schematic illustrations of 1.5L₀ thick A-b-B block copolymer films assembled between a low density B-stripe chemical pattern and a surface C.

FIGS. 8A-8E provide cross-sectional schematic illustrations of 1.0L₀ thick A-b-B block copolymer films assembled between a low density B-stripe chemical pattern and a surface C.

FIGS. 9A-9C provide cross-sectional schematic illustrations of 1.25L₀ thick A-b-B block copolymer films assembled between a low density B-stripe chemical pattern and a surface C.

### DETAILED DESCRIPTION

### 1. Introduction

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Provided herein are novel methods of directing the assembly of block copolymer (BCP) thin films. In some embodiments, the methods include directing the assembly of a BCP thin film between a patterned surface and a topcoat surface, with the topcoat surface being preferential to one of the component polymers of the BCP and establishing a boundary condition that induces perpendicular orientation throughout the entire thickness of the film. In some embodiments, the patterned surface has a pattern with a density less than that of the assembled BCP thin film.

Advantages according to certain embodiments include directed assembly of vertically oriented structures using block copolymers with sub-10 nm domains and large differences in surface energy between blocks that could not be assembled previously. The block copolymers can have high etch selectivity. Assembly of these types of polymers can be useful for lithographic applications in the semiconductor industry, information storage, and fabricating nanoimprint templates. Advantages also can include directed assembly of thick films with precise control over three-dimensional structures for membrane and separations applications, templates for energy harvesting applications, plasmonics, and photonics. The structures may have gradients in characteristic dimensions, or non-regular feature shapes.

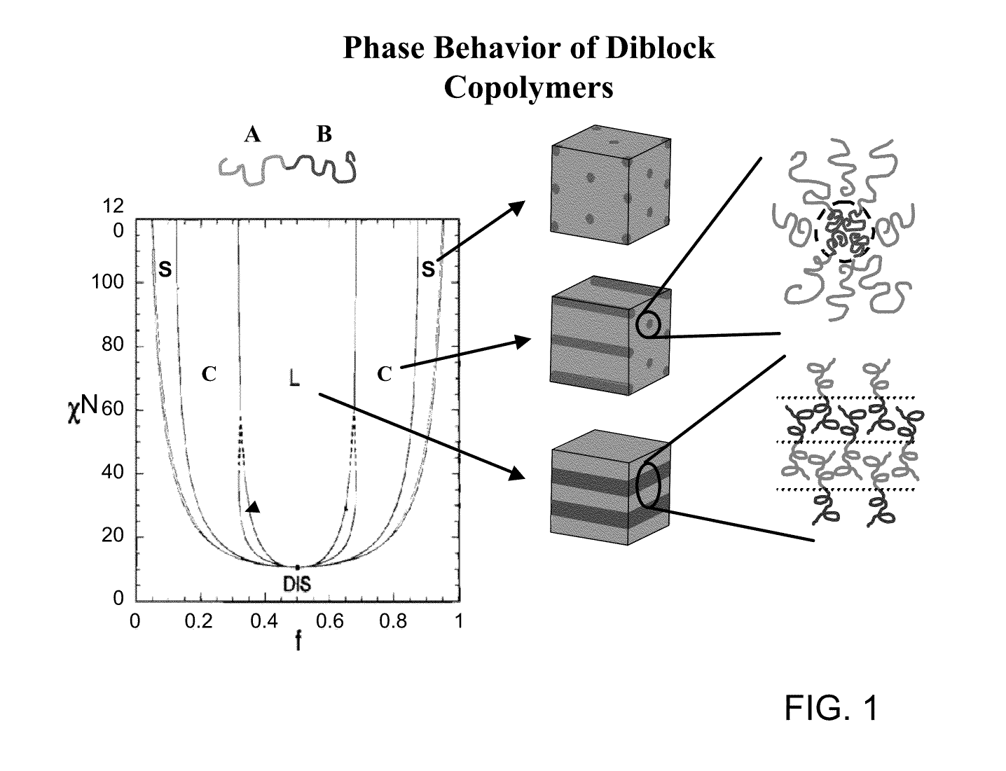

Self-assembling materials spontaneously form structures at length scales of interest in nanotechnology. In the particular case of block copolymers, the thermodynamic driving forces for self-assembly are small and low-energy defects can get easily trapped. Block copolymers are a class of polymers that have two or more polymeric blocks. The structure of diblock copolymer AB, also denoted A-b-B, may correspond, for example, to AAAAAAA-BBBBBBBB. FIG. 1 shows theoretical phase behavior of diblock copolymers. The graph in FIG. 1 shows, χN (where χ is the Flory-Huggins interaction parameter and N is the degree of polymerization) as a function of the volume fraction, f, of a block (A) in a diblock (A-b-B) copolymer. χN is related to the energy of mixing the blocks in a diblock copolymer and is inversely proportional to temperature. FIG. 1 shows that at a particular temperature and volume fraction of A, the diblock copolymers microphase separate into domains of different morphological features. As indicated in FIG. 1, when the volume fraction of either block is around 0.1, the block copolymer will microphase separate into spherical domains (S), where one block of the copolymer surrounds spheres of the other block. As the volume fraction of either block nears around 0.2-0.3, the blocks separate to form a hexagonal array of cylinders (C), where one block of the copolymer surrounds cylinders of the other block. And when the volume fractions of the blocks are approximately equal, lamellar domains (L) or alternating stripes of the blocks are formed. Representations of the cylindrical and lamellar domains at a molecular level are also shown. Domain size typically ranges from 2 nm or 3 nm to 50 nm. The phase behavior of block copolymers containing more than two types of blocks (e.g. A-b-B-b-C), also results in microphase separation into different domains. The size and shape of the domains in the bulk depend on the overall degree of polymerization N, the repeat unit length a, the volume fraction f of one of the components f, and, to a lesser extent, the Flory-Huggins interaction parameter, χ.

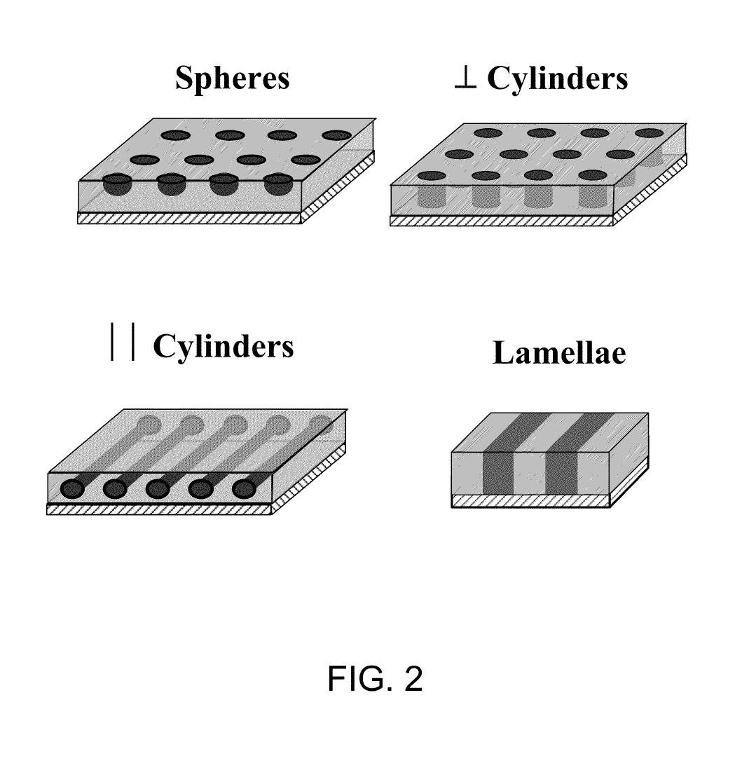

FIG. 2 shows spherical, cylindrical and lamellar ordered domains formed on substrates. Domains (spheres, cylinders or lamellae) of one block of the copolymer are surrounded by the other block copolymer. As shown in FIG. 2, cylinders may form parallel or perpendicular to the substrate. While the FIGS. 1 and 2 show phase behavior of diblock copolymers for illustrative purposes, the phase behavior of block copolymers containing more than two types of blocks (e.g., A-b-B-b-C) also results in microphase separation into different architectures.

Self-assembly of BCPs in bulk and the translation of random ordered block copolymer domains into thin-films has emerged as a powerful approach to create functional nanostructures and templates for various applications. Block copolymer lithography refers to the use of ordered block copolymer domains in thin-film form as templates for patterning, e.g., through selective etching or deposition. The resulting nanostructures, such as dense periodic arrays, may be used in applications such as bit patterned media, FLASH memory, nanowire transistors, quantum dot arrays, separation membranes, photonic crystals and photovoltaic cells. As described with reference to self-assembly of BCPs in thin-films form may involve depositing a BCP solution on a patterned buffer or imaging layer on a substrate, then inducing the BCP to separate into domains.

A block copolymer material may be characterized by bulk lattice constant or period Lₒ. For example, a lamellar block copolymer film has a bulk lamellar period or repeat unit, Lₒ. For cylindrical and spherical domain structures, the periodicity of the bulk domain structures can be characterized by the distance between the cylinders or spheres, e.g., in a hexagonal array. Periodic patterns formed on substrates or in thin block copolymer films may also be characterized by characteristic lengths. “L” is used herein to denote a characteristic length or spacing in a pattern. It may be referred to as a lattice constant, pitch, period or length. For example, a lamellar period Lₛ of a two-phase lamellar substrate pattern is the width of two stripes. Lₛ is used herein to denote the period, pitch, lattice constant or other characteristic length of a substrate pattern.

Fabricating patterns smaller than 10 nm scale with BCP lithography can be achieved by using BCPs with fairly large Flory-Huggins interaction parameters (χs) that enable the micro-phase separation of small molecular weight BCPs. However, these BCP's tend to have dissimilar surface energies γₛ, which leads to preferential wetting of one block at the free surface of the film and/or lead to parallel microdomain structures. Described herein are methods of inducing perpendicular orientation throughout the thickness of the BCP film. In some embodiments, the methods involve using a topcoat polymer or other topcoat surface to provide a boundary condition that allows a perpendicular orientation of the thickness of the film. In some embodiments, the topcoat polymer is a homopolymer. In some embodiments, the topcoat polymer is preferential to one or more blocks of the constituent blocks of the BCP. Previously, perpendicular orientation throughout the entire thickness of a film was achieved only by using BCP's with constituent blocks with similar polymer-air surface energies (γ) such as PS-b-PMMA and/or providing a top surface (neutral) non-preferential to the constituent blocks of the BCP, such as a random copolymer of the BCP component polymers.

The methods described herein allow control of both lateral structure and perpendicular orientation of large χBCP thin films. The interfacial energies of a BCP film contribute to the orientation of a BCP film allowed to self-assemble in the presence of a chemical pattern. There are at least two interfaces in such a system: the BCP interface at the bottom, patterned substrate and the interface at the free or top surface of a BCP film.

As indicated above, methods of fabricating block copolymers thin films that involve directing the assembly of block copolymer materials sandwiched between two condensed phases are described herein. One surface of the two surfaces is chemically patterned such that the block copolymer material self-assembles in accordance with the chemical pattern. For the purposes of discussion, this surface may be referred to as the “bottom surface” in this discussion, though it is not necessarily on bottom during assembly or thereafter. According to various embodiments, the other of the two surfaces is unpatterned and chemically homogenous. For the purposes of discussion, this surface may be referred to as the “top surface,” though it is not necessarily on top during assembly or thereafter. The bottom surface may be referred to as a surface of a substrate and the top surface may be referred to as a surface of a superstrate.

Surface energy, as used herein, can refer to energy at the surface between a condensed and non-condensed phase, such as a solid block copolymer thin film or block copolymer film in the melt and a gas or vacuum. Interfacial energy, as used herein, can refer to energy at the surface between two condensed phases, such as a solid block copolymer thin film or block copolymer thin film in the melt and a liquid or solid. In some description herein, interfacial energy may be used to refer to the energy between any two phases.

In some embodiments, the methods described herein are based on considering the interfacial energies of a BCP film placed on a chemical pattern. There are at least two interfaces in such a system: the interface at the bottom (patterned) substrate and the interface at the superstrate or free surface if there is no top surface. If different orientations are present in the film, the interface between the regions is also taken into account.

In some embodiments, the methods described herein involve using polymers (or other top surfaces) that make a perpendicular orientation of an assembled BCP film thermodynamically favored. For a symmetric A-b-B block copolymer on a 1:1 A/B chemical pattern, this can be estimated as a top surface C for which the following condition is met:

$$\frac{1}{2} \vert {γ}_{A - C} - {γ}_{B - C} \vert < \frac{1}{2} {γ}_{A - B} \qquad ( Equation 1 )$$

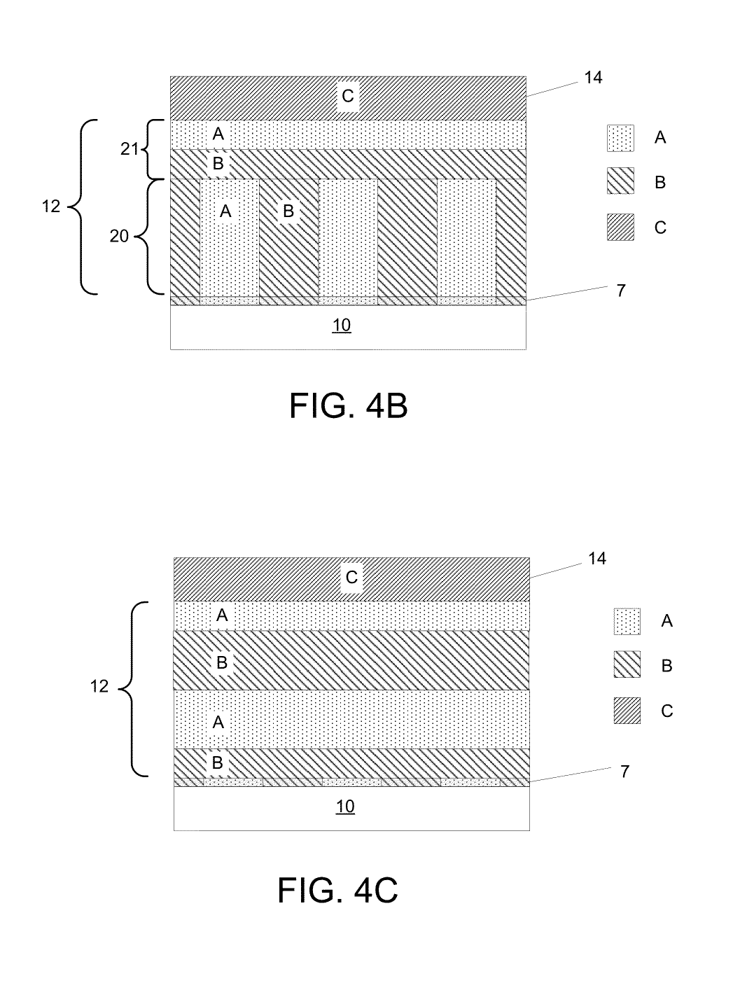

with γ_{A-C}, γ_{B-C}, and γ_{A-B} the interfacial energies of each A-C, B-C and A-B polymer pair. Accordingly, for a symmetric A-b-B block copolymer on a 1:1 A/B chemical pattern, a topcoat surface C for which the above condition is met can be used to generate perpendicular orientation throughout the thickness of the film, without a top wetting layer. This allows top surfaces C, including homopolymers, that are preferential to A or B to be used. The determination of the above condition is described below with reference to FIGS. 4A-4C and Table 1, with the described approach extendible to other systems.

Table 1, below, describes the estimated interfacial energies of an A-b-B BCP film assembled between an A/B chemical pattern and a topcoat C surface for five theoretical cases of assembly:
(1) Both A and B block wetting on C (i.e, perpendicular orientation throughout film);
(2) A block only wetting on C (mixed perpendicular and parallel orientation);
(3) A block only wetting on C (parallel orientation);
(4) B block only wetting on C (mixed perpendicular and parallel orientation); and
(5) B block only wetting on C (parallel orientation).

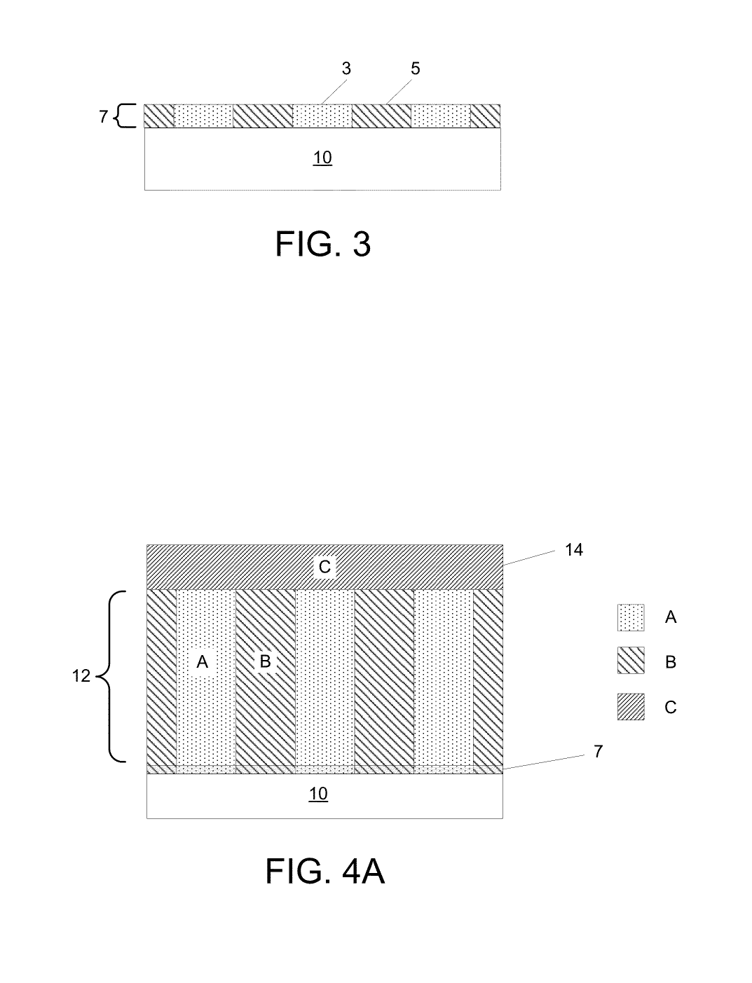

FIG. 3 provides a cross-sectional schematic illustration of an A/B chemical pattern on a substrate. FIGS. 4A-4C illustrate each of the first three cases, with the fourth and fifth cases analogous to the second and third cases, respectively. First, FIG. 3 shows a A/B chemical pattern 7 made up of alternating regions 3 and 5 of a polymer A and polymer B, respectively, on a substrate 10. It should be noted that the A/B chemical pattern 7 is expanded in the vertical direction in FIG. 3 relative to FIGS. 4A-4C for illustrative purposes. Turning to FIG. 4A, a microphase separated A-b-B film 12 assembled between the A/B chemical pattern 7 and a C top surface 14 is schematically depicted. The lamellar micro A and B domains of the microphase separated A-b-B film 12 are registered with the patterned A and B regions, respectively, of the A/B chemical pattern 7. In this case, both the A and B domains wet the C top surface 14, with the lamellae oriented perpendicular to the substrate 10 throughout the thickness of the microphase separated A-b-B film 12.

FIG. 4B depicts the second case, in which only the A block wets the C top surface 14, with the microphase separated A-b-B film 12 having a mixed perpendicular/parallel orientation. The domains of microphase separated A-b-B film 12 are oriented perpendicular to the substrate 10 in portion 20 of the film adjacent to the A/B chemical pattern 7 and parallel to the substrate 10 in portion 21 of the film adjacent to the C top surface 14. The C top surface 14 is wet by a parallel A domain. (The assembled film depicted in FIG. 4B is analogous to the case where only the B block wets C, with the film having a mixed perpendicular and parallel orientation. In that case, a B domain would wet the C top surface 14).

FIG. 4C depicts the third case, in which only the A block wets the C top surface 14, with the microphase separated A-b-B film 12 having a parallel orientation. The domains of microphase separated A-b-B film 12 are oriented parallel to the substrate 10 throughout the thickness of the A-b-B film 12. The C top surface 14 is wet by a parallel A domain. (The assembled film depicted in FIG. 4C is analogous to the case where only the B block wets C, with the film having a parallel orientation. In that case, a B domain would wet the C top surface 14).

Table 1, below, shows the total interfacial energy estimates of A-b-B films with the possible wetting behaviors and orientations described above with references to FIGS. 4A-4C.

TABLE 1
Interfacial energy estimate of A-b-B
film between A/B pattern and C surface

| | Both A&B | | | | |
|---|---|---|---|---|---|
| | block wetting | A block | | B block | |
| Interfacial | on C | wetting on C | | wetting on C | |
| Energy | Perpendicular | Mixed | Parallel | Mixed | Parallel |
| Top | ½(γ_{A-C} + γ_{B-C}) | γ_{A-C} | γ_{A-C} | γ_{B-C} | γ_{B-C} |
| Inside | | ½γ_{A-B} | | ½γ_{A-B} | |
| Bottom | | | ½γ_{A-B} | | ½γ_{A-B} |

| | | | |
|---|---|---|---|
| Total | ½(γ_{A-C} + γ_{B-C}) | γ_{A-C} + ½γ_{A-B} | γ_{B-C} + ½γ_{A-B} |

For an 1.5L₀ thick A-b-B film assembled between an A/B pattern and a topcoat C, the perpendicular orientation is most stable if one of the below conditions is met:

$$\begin{matrix}\frac{1}{2} ( {γ}_{A - C} + {γ}_{B - C} ) < {γ}_{A - C} + \frac{1}{2} {γ}_{A - B} & ( Equation 2 ) \\ \frac{1}{2} ( {γ}_{A - C} + {γ}_{B - C} ) < {γ}_{B - C} + \frac{1}{2} {γ}_{A - B} & ( Equation 3 )\end{matrix}$$

This condition can be rewritten as Equation 1 above. The relationship in Equation 1 suggests that an energetically favorable perpendicular orientation of an A-b-B film can be obtained by a polymer (or other surface) C that makes the difference in the interfacial energy against both blocks (the energy penalty at the top for the perpendicular orientation) smaller than the interfacial energy between A and B (the energy penalty inside for mixed orientations or at the patterned substrate for parallel orientations).

The above approach can be validated by considering and comparing representative models of a lamellar-forming polystyrene-block-poly(methyl methacrylate) (PS-b-PMMA) film assembled between a PS/PMMA line pattern and a free surface and a lamellar-forming polystyrene-block-poly(2-vinyl pyridine) PS-b-P2VP assembled between a PS/P2VP line pattern and a free surface, with PS-b-PMMA a relatively small χBCP and a PS-b-P2VP a relatively large χBCP.

The surface energies of PS, PMMA, and P2VP at a free surface (air) and the interfacial energies of each polymer pair are in Table 2, below. Interfacial energies were estimated by the harmonic mean equation.

TABLE 2
Surface energies of PS, PMMA, and
P2VP and their interfacial energies

| | | | | | Interfacial |
|---|---|---|---|---|---|
| | Surface Energy (mJ/m²) | | | | Energy |
| Polymer | total | dispersive | polar | Polymer Pair | (mJ/m²) |
| PS (γ_{S}) | 40.7 | 33.9 | 6.8 | PS-PMMA (γ_{S-M}) | 1.5 |
| PMMA | 41.1 | 29.6 | 11.5 | P2VP-PMMA | 3.2 |
| (γ_{M}) | | | | (γ_{V-M}) | |
| P2VP (γ_{V}) | 49.4 | 27.6 | 21.8 | PS-P2VP (γ_{S-V}) | 8.5 |

Table 3, below, shows the interfacial energy for PS-b-PMMA and PS-b-P2VP films on 1:1 chemical patterns based on the above surface and interfacial energies.

TABLE 3
Estimate of interfacial energy of PS-b-PMMA and PS-b-P2VP films on
chemical patterns with a free top surface

| Interfacial | PS-b-PMMA | | | PS-b-P2VP | | |
|---|---|---|---|---|---|---|
| Energy | Perpendicular | Mixed | Parallel | Perpendicular | Mixed | Parallel |
| Top | ½(γ_{M} + γ_{S}) | γ_{S} | γ_{S} | ½(γ_{S} + γ_{V}) | γ_{S} | γ_{S} |
| Inside | | ½(γ_{S-M}) | | | ½(γ_{S-V}) | |
| Bottom | | | ½(γ_{S-M}) | | | ½(γ_{S-V}) |
| Total | 40.9 | 41.4 | 41.4 | 45.1 | 44.9 | 44.9 |
| (mJ/m²) | | | | | | |

For the estimates in Table 3, interfacial energy at the top of a film is the surface energy of the polymer exposed at the free surface of a BCP film. It was assumed that the surface or interfacial property of the chemical pattern is identical to that of the corresponding polymer of the BCP. As shown in Table 3, the perpendicular orientation of small χBCP, PS-b-PMMA, is energetically favorable whereas the parallel or mixed orientation of large χBCP, PS-b-P2VP, is more stable than the perpendicular orientation.

Even though the energy penalty of having mixed or parallel morphology in a PS-b-P2VP film is not small (½(γ_{S-V})), the PS-b-P2VP film in this system cannot be perpendicularly oriented because the energy penalty of perpendicular orientation that makes P2VP domain exposed to the surface is significantly large. The PS-b-PMMA film can assemble perpendicularly according to Table 3. These results accord with experimentation. To make the perpendicular orientation of large χBCP film energetically stable, the energy penalty at the free surface of a BCP film is reduced, following Equation 1.

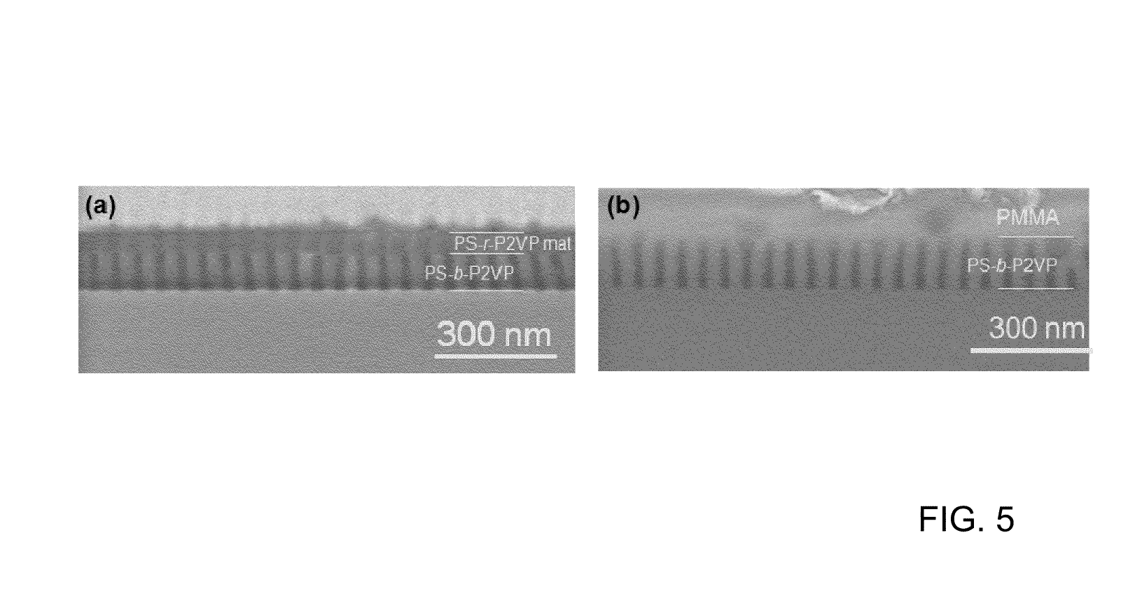

While a non-preferential polymer, such as a PS-r-P2VP random copolymer, can be used as a top surface for PS-r-P2VP assembly to make the interfacial energy at the top surface identical, allowing perpendicular orientation throughout the film, the topcoat approach is not limited to neutral random copolymers. The condition in Equation 1 and pairwise interaction energies in Table 2 suggest that a PMMA film as a top surface in a PS-b-P2VP system to achieve parallel orientation. PMMA reduces the energy penalty at the top surface for perpendicular orientation of a PS-b-P2VP film (½(γ_{V-M}−γ_{S-M})=0.85 mJ/m²), which is significantly smaller than the energy penalty stemming from parallel orientation (½γ_{S-V}=4.25 mJ/m²). FIG. 5 shows cross-sectional FE-SEM images of assembled PS-b-P2VP films on PS/P2VP chemical patterns under (a) a PS-r-P2VP mat and (b) a PMMA film. The image shows that the perpendicular orientation of the assembled PS-b-P2VP film under a PMMA film is at least comparable to that under a neutral PS-r-P2VP mat. This validates the approach described above, with appropriate combinations of BCP and topcoat polymers applied to achieve successful directed assembly of large χBCP films on chemical patterns.

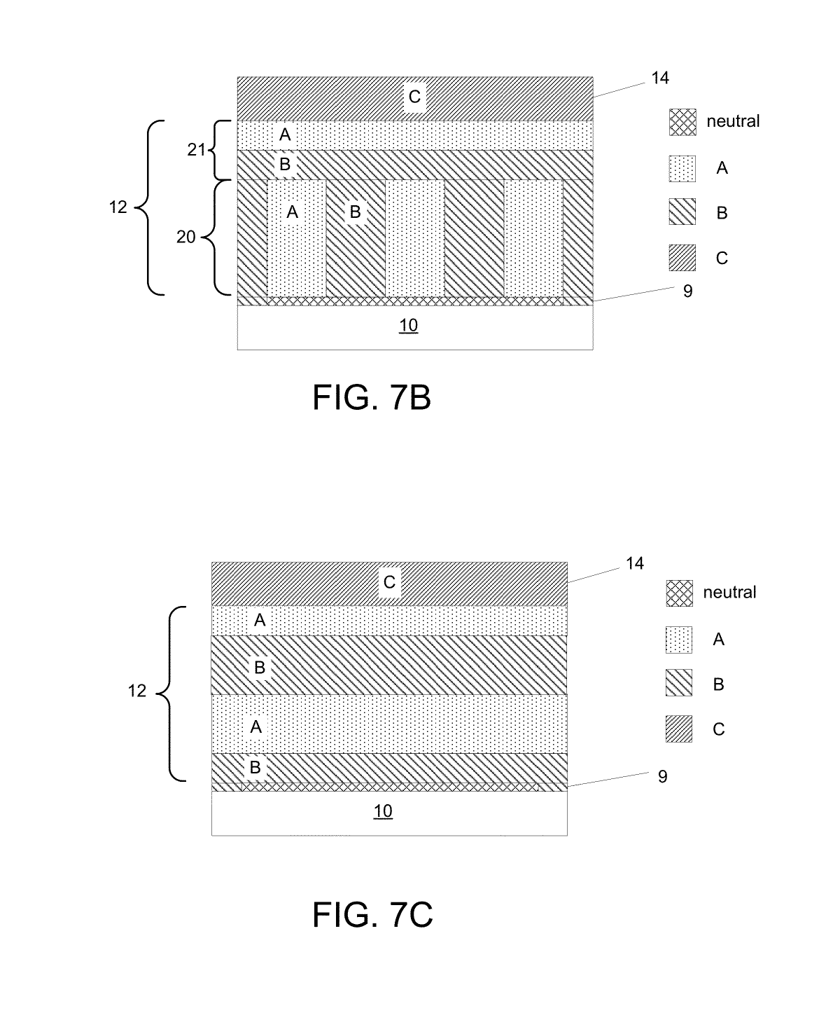

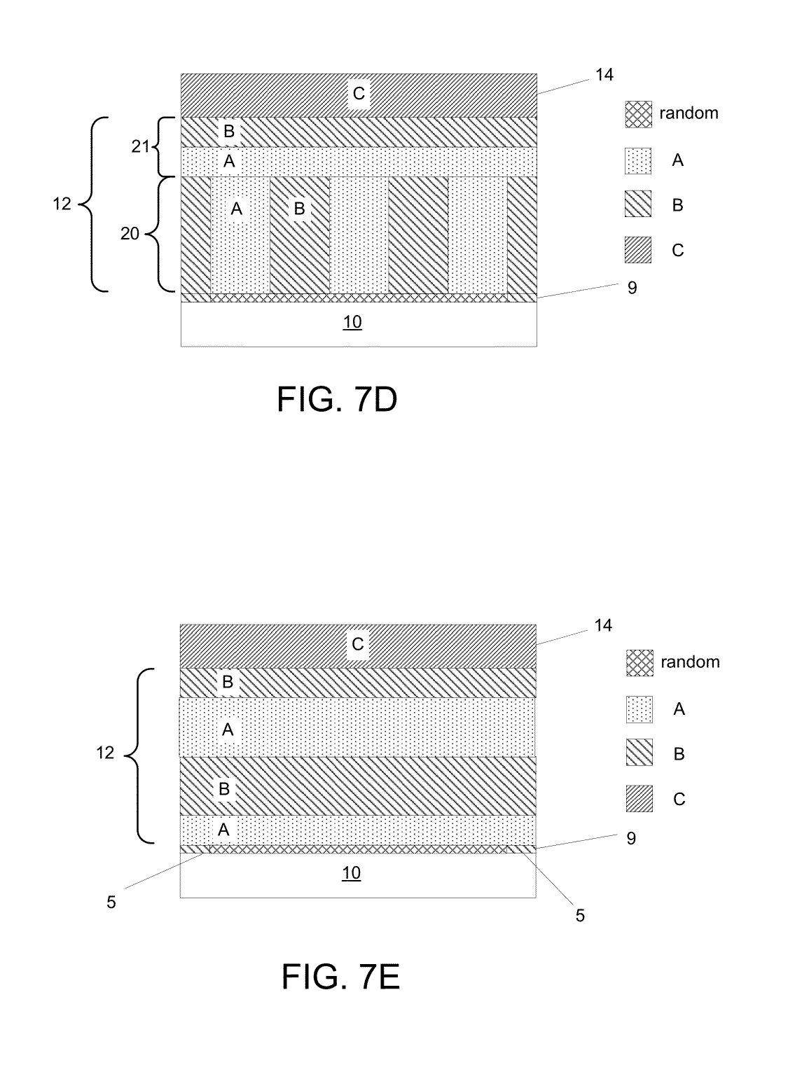

While Equation 1 is applicable to symmetric lamellar-forming A-b-B BCP's on 1:1 striped A/B patterns with a film thickness of 1.5L₀, the described approach is extendible to other systems, including cylindrical-forming A-b-B BCP's, triblock and higher order BCP's, and substrates patterned with chemistries other than A/B, by appropriately considering the interfacial energies of the top, inside and bottom interfaces for various domain orientations, as described above. In some embodiments, the strength of interaction between the chemical pattern and the components of the BCP could be modified to change the terms in the “bottom” row of Table 1, for example, thereby modifying the condition to obtain perpendicular orientation throughout the thickness of the film. An example of a pattern including non-preferential area is described below with reference to FIGS. 7A-7E and Table 4. Moreover, as described further below, a top surface that allows perpendicular orientation may depend on the film thickness.

In some implementations, the methods described herein may be used to assemble large χBCP films on lower density patterns using density multiplication. Density multiplication refers to multiplying the density of pattern features; some percentage of the features of the desired pattern are removed, with the spacing of the remaining pattern features left intact and is described in US Patent Publication No. 2009-0196488 incorporated by reference herein.

Table 4, below, summarizes the estimated interfacial energies of an A-b-B 1.5L₀ thick BCP film assembled between a chemical pattern including B stripes and a topcoat C surface with 3× density multiplication for five theoretical cases of assembly:
(1) Both A and B block wetting on C (i.e, perpendicular orientation throughout film);
(2) A block only wetting on C (mixed perpendicular and parallel orientation);
(3) A block only wetting on C (parallel orientation);
(4) B block only wetting on C (mixed perpendicular and parallel orientation); and
(5) B block only wetting on C (parallel orientation).

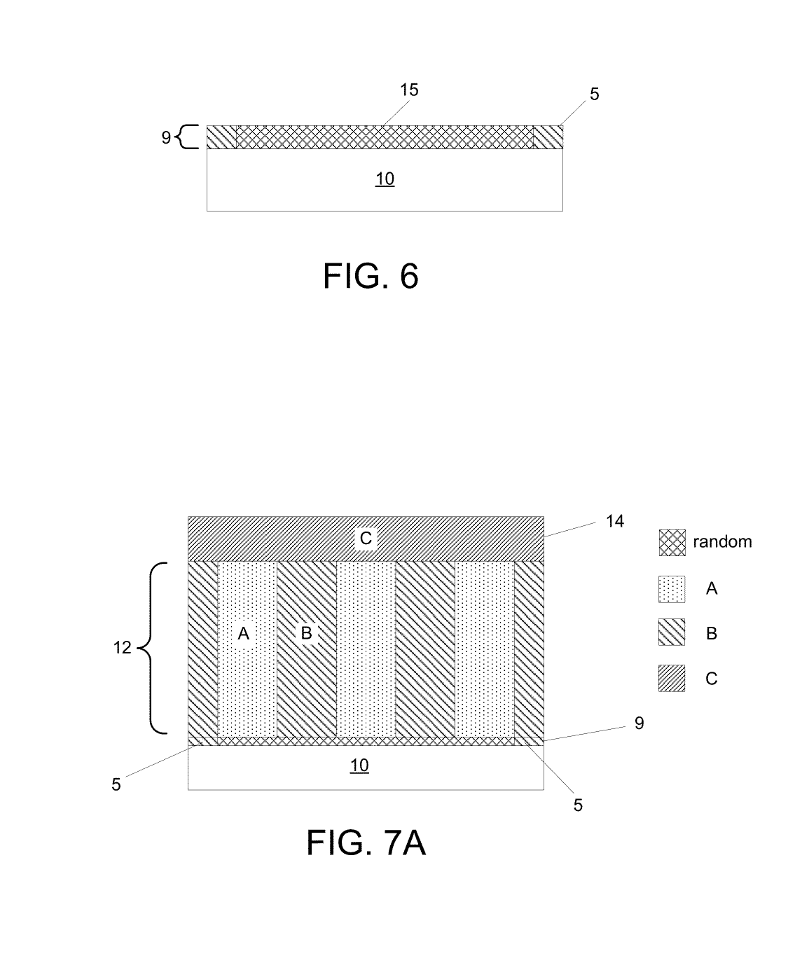

FIG. 6 provides a cross-sectional schematic illustration of a B-stripe chemical pattern for 3× density multiplication on a substrate. FIGS. 7A-7E illustrate the five cases described above, which are analogous to possible assemblies on a low density pattern of A stripes. First, FIG. 6 shows a low density B-stripe pattern 9 including regions 5 of a polymer B on a substrate 10 separated by non-preferential regions 15. The regions 5 of the B polymer in FIG. 6 are patterned at a density ⅓ of that of the regions 5 in FIG. 3. The non-preferential regions 15 can be for example, a A-r-B random copolymer or other non-preferential (neutral) surface.

Turning to FIG. 7A, a microphase separated A-b-B film 12 assembled between the low density B-stripe pattern 9 and a C top surface 14 is schematically depicted. The B regions 5 of the B-stripe chemical pattern 5 guide the assembly of the A-b-B film 12, such that lamellar B domains are registered with the regions 5, and A and B lamellae are precisely located over the non-preferential regions 15 such that they are registered with an ideal pattern of 3× the density of the low density B-stripe pattern 9. In this case, both the A and B domains wet the C top surface 14, with the lamellae oriented perpendicular to the substrate 10 throughout the thickness of the microphase separated A-b-B film 12.

FIG. 7B depicts the second case, in which only the A block wets the C top surface 14, with the microphase separated A-b-B film 12 having a mixed perpendicular/parallel orientation. The domains of microphase separated A-b-B film 12 are oriented perpendicular to the substrate 10 in portion 20 of the film adjacent to the low density B-stripe chemical pattern 9 and parallel to the substrate 10 in portion 21 of the film adjacent to the C top surface 14. The C top surface 14 is wet by a parallel A domain.

FIG. 7C depicts the third case, in which only the A block wets the C top surface 14, with the microphase separated A-b-B film 12 having a parallel orientation. The domains of microphase separated A-b-B film 12 are oriented parallel to the substrate 10 throughout the thickness of the A-b-B film 12. The C top surface 14 is wet by a parallel A domain.

FIG. 7D depicts the fourth case, in which only the B block wets the C top surface 14, with the microphase separated A-b-B film 12 having a mixed perpendicular/parallel orientation. The domains of microphase separated A-b-B film 12 are oriented perpendicular to the substrate 10 in portion 20 of the film adjacent to the low density B-stripe chemical pattern 9 and parallel to the substrate 10 in portion 21 of the film adjacent to the C top surface 14. The C top surface 14 is wet by a parallel B domain.

FIG. 7E depicts the fifth case, in which only the B block wets the C top surface 14, with the microphase separated A-b-B film 12 having a parallel orientation. The domains of microphase separated A-b-B film 12 are oriented parallel to the substrate 10 throughout the thickness of the A-b-B film 12. The C top surface 14 is wet by a parallel B domain. The low density B-stripe pattern 9 is wet by a parallel A domain.

Table 4, below, shows the total interfacial energy estimates of A-b-B films with the possible wetting behaviors and orientations described above with references to FIGS. 7A-7E.

TABLE 4
Interfacial energy estimate of 1.5L₀ thick A-b-B film between 1/3 density B-
stripe pattern and C surface

| | Both A&B | | | | |
|---|---|---|---|---|---|
| | block wetting | A block wetting on C | | B block wetting on C | |
| | on C | (γ_{A-C} < γ_{B-C}) | | (γ_{B-C} < γ_{A-C}) | |
| Interfacial | Perpendicular | Mixed | Parallel | Mixed | Parallel |
| Energy | (case (1)) | (case (2)) | (case (3)) | (case (4)) | (case (5)) |
| Top | ½(γ_{A-C} + γ_{B-C}) | γ_{A-C} | γ_{A-C} | γ_{B-C} | γ_{B-C} |
| Inside | | ½γ_{A-B} | | ½γ_{A-B} | |
| Bottom | $\frac{3}{6} {γ}_{A \text{-} ran} + \frac{2}{6} {γ}_{B \text{-} ran}$ | $\frac{3}{6} {γ}_{A \text{-} ran} + \frac{2}{6} {γ}_{B \text{-} ran}$ | $\frac{5}{6} {γ}_{B \text{-} ran}$ | $\frac{3}{6} {γ}_{A \text{-} ran} + \frac{2}{6} {γ}_{B \text{-} ran}$ | $\frac{5}{6} {γ}_{A \text{-} ran} + \frac{1}{6} {γ}_{B \text{-} ran}$ |

For both the A block only wetting on C and the B block only wetting on C cases, the parallel orientation (cases (3) and (5)) is favored over the mixed orientation (cases (2) and (4)), assuming the random surface is non-preferential to the A and B polymers. Case (1) is always larger than case (3) because γ_{A-C}<γ_{B-C} for A block only wetting on C. This indicates that for a ⅓ density B-striped pattern, a 1.5L₀ film cannot achieve perpendicular orientation throughout the film thickness if γ_{A-C}<γ_{B-C}. However, case (1) can be favored if both the following conditions are met:

$$\begin{matrix}{γ}_{B - C} < {γ}_{A - C} ; \\ and & ( Equation 4 ) \\ {γ}_{A - C} - {γ}_{B - C} < \frac{1}{3} {γ}_{A - B} & ( Equation 5 )\end{matrix}$$

Similarly, for a ⅓ density A-striped pattern, a 1.5L₀ A-b-B film can achieve perpendicular orientation throughout the film thickness if both the following conditions are met:

$$\begin{matrix}{γ}_{A - C} < {γ}_{B - C} ; \\ and & ( Equation 6 ) \\ {γ}_{B - C} - {γ}_{A - C} < \frac{1}{3} {γ}_{A - B} & ( Equation 7 )\end{matrix}$$

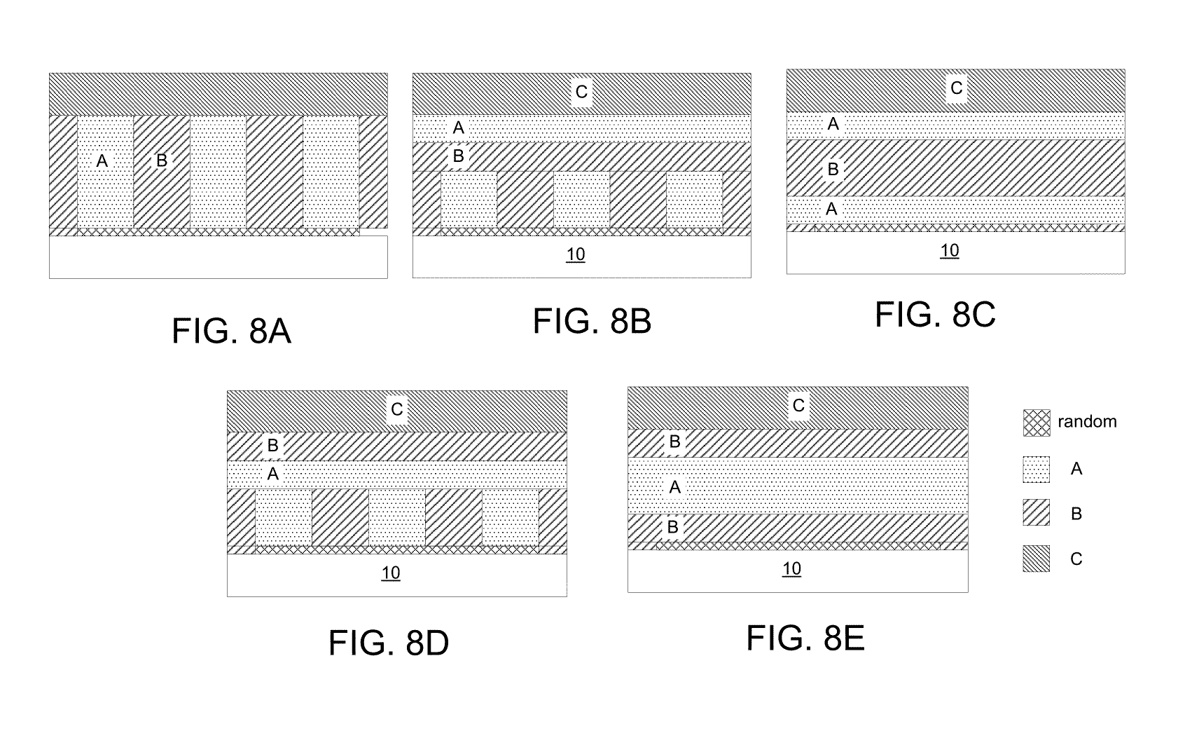

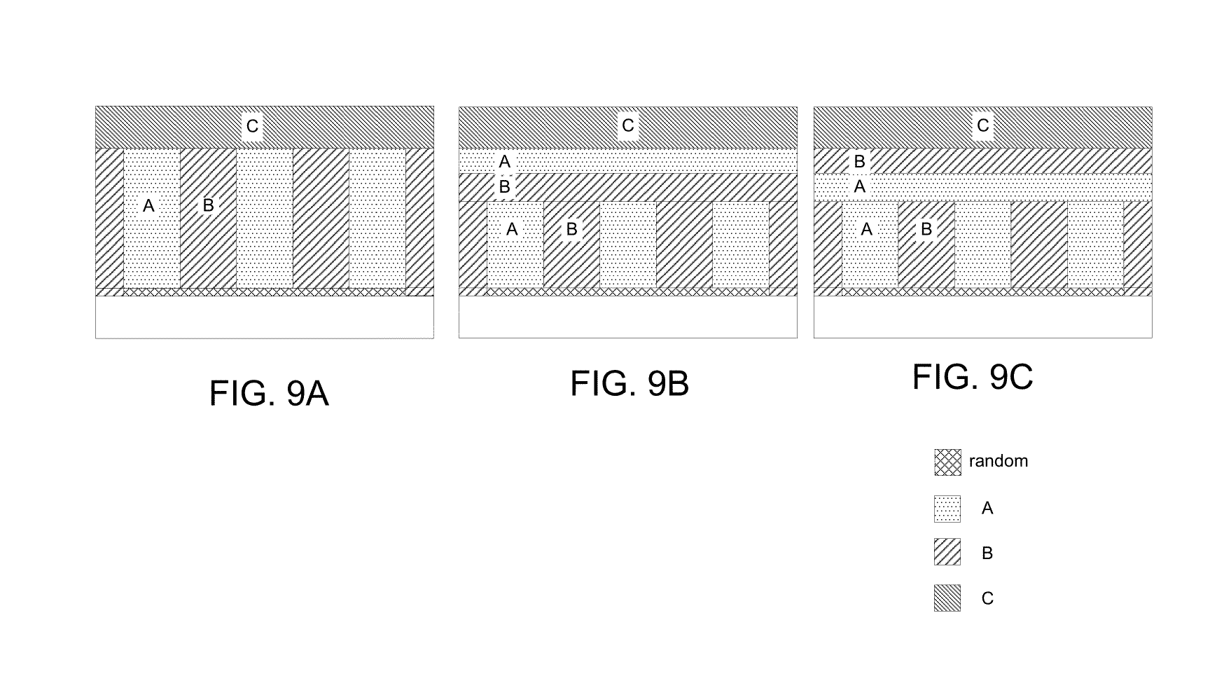

As indicated above, the systems for which perpendicular orientation of BCP film will result depend in part of the thickness of the BCP film. The previously considered cases and systems illustrated in FIGS. 4A-4C and 7A-7E are for 1.5L₀ thick BCP films. FIGS. 8A-8E and 9A-9C are cross-sectional schematic illustrations of the BCP system described above with reference to FIGS. 7A-7E for a BCP film thickness of 1.0L₀ and 1.25L₀, respectively. FIGS. 8A-8E illustrate the following cases for a 1.0L₀ thick film on a ⅓ density B-stripe pattern:
(1) Both A and B block wetting on C (i.e, perpendicular orientation throughout film);
(2) A block only wetting on C (mixed perpendicular and parallel orientation);
(3) A block only wetting on C (parallel orientation);
(4) B block only wetting on C (mixed perpendicular and parallel orientation); and
(5) B block only wetting on C (parallel orientation).

Table 5, below, shows the total interfacial energy estimates of A-b-B films with the possible wetting behaviors and orientations shown in FIGS. 8A-8E.

TABLE 5
Interfacial energy estimate of 1.0L₀ thick A-b-B film between 1/3 density B-
stripe pattern and C surface

| | Both A&B | | | | |
|---|---|---|---|---|---|
| | block wetting | A block wetting on C | | B block wetting on C | |
| | on C | (γ_{A-C} < γ_{B-C}) | | (γ_{B-C} < γ_{A-C}) | |
| Interfacial | Perpendicular | Mixed | Parallel | Mixed | Parallel |
| Energy | (case (1)) | (case (2)) | (case (3)) | (case (4)) | (case (5)) |
| Top | ½(γ_{A-C} + γ_{B-C}) | γ_{A-C} | γ_{A-C} | γ_{B-C} | γ_{B-C} |
| Inside | | ½γ_{A-B} | | ½γ_{A-B} | |
| Bottom | $\frac{3}{6} {γ}_{A \text{-} ran} + \frac{2}{6} {γ}_{B \text{-} ran}$ | $\frac{3}{6} {γ}_{A \text{-} ran} + \frac{2}{6} {γ}_{B \text{-} ran}$ | $\frac{5}{6} {γ}_{A \text{-} ran} + \frac{1}{6} {γ}_{A \text{-} B}$ | $\frac{3}{6} {γ}_{A \text{-} ran} + \frac{2}{6} {γ}_{B \text{-} ran}$ | $\frac{5}{6} {γ}_{B \text{-} ran}$ |

Case (1) can be favored if both the following conditions are met:

$$\begin{matrix}{γ}_{A - C} < {γ}_{B - C} ; \\ and & ( Equation 6 ) \\ {γ}_{B - C} - {γ}_{A - C} < \frac{1}{3} {γ}_{A - B} & ( Equation 7 )\end{matrix}$$

It is noted that for a BCP thickness of L₀ on a B-striped pattern, the conditions that result in perpendicular orientation are the same as for a BCP thickness of 1.5L₀ on an A-striped pattern. Similarly, the conditions that result in perpendicular orientation for a BCP thickness of L₀ on a A-striped pattern are the same as for a BCP thickness of 1.5L₀ on an B-striped pattern:

$$\begin{matrix}{γ}_{B - C} < {γ}_{A - C} ; \\ and & ( Equation 4 ) \\ {γ}_{A - C} - {γ}_{B - C} < \frac{1}{3} {γ}_{A - B} & ( Equation 5 )\end{matrix}$$

FIGS. 9A-9C are schematics of the following possible cases of assembly for a 1.25L₀ thick A-b-B BCP between a ⅓ density B-striped pattern and a topcoat C surface:
(1) Both A and B block wetting on C (i.e, perpendicular orientation throughout film);
(2) A block only wetting on C (mixed perpendicular and parallel orientation); and
(3) B block only wetting on C (mixed perpendicular and parallel orientation).

Parallel only orientations (not shown) for a 1.25L₀ thick film are not thermodynamically favored.

Table 6, below, summarizes the estimated interfacial energies of an A-b-B 1.25L₀ thick BCP film assembled between a chemical pattern of B stripes and a topcoat C surface with 3× density multiplication for the wetting behavior and orientations described above with respect to FIGS. 9A-9C.

TABLE 6
Interfacial energy estimate of 1.25L₀ thick A-b-B film between 1/3 density
B-stripe pattern and C surface

| | Both A&B | A block | B block |
|---|---|---|---|
| | block wetting | wetting on C | wetting on C |
| | on C | (γ_{A-C} < γ_{B-C}) | (γ_{B-C} < γ_{A-C}) |
| Interfacial | Perpendicular | Mixed | Mixed |
| Energy | (case (1)) | (case (2)) | (case (3)) |
| Top | ½(γ_{A-C} + γ_{B-C}) | γ_{A-C} | γ_{B-C} |
| Inside | | ½γ_{A-B} | ½γ_{A-B} |
| Bottom | $\frac{3}{6} {γ}_{A \text{-} ran} + \frac{2}{6} {γ}_{B \text{-} ran}$ | $\frac{3}{6} {γ}_{A \text{-} ran} + \frac{2}{6} {γ}_{B \text{-} ran}$ | $\frac{3}{6} {γ}_{A \text{-} ran} + \frac{2}{6} {γ}_{B \text{-} ran}$ |

Table 7, below, summarizes the estimated interfacial energies of an A-b-B 1.25L₀ thick BCP film assembled between a chemical pattern of A stripes and a topcoat C surface with 3× density multiplication for the wetting behavior.

TABLE 7
Interfacial energy estimate of 1.25L₀ thick A-b-B film between 1/3 density
A-stripe pattern and C surface

| | Both A&B | A block | B block |
|---|---|---|---|
| | block wetting | wetting on C | wetting on C |
| | on C | (γ_{A-C} < γ_{B-C}) | (γ_{B-C} < γ_{A-C}) |
| Interfacial | Perpendicular | Mixed | Mixed |
| Energy | (case (1)) | (case (2)) | (case (3)) |
| Top | ½(γ_{A-C} + γ_{B-C}) | γ_{A-C} | γ_{B-C} |
| Inside | | ½γ_{A-B} | ½γ_{A-B} |
| Bottom | $\frac{3}{6} {γ}_{B \text{-} ran} + \frac{2}{6} {γ}_{A \text{-} ran}$ | $\frac{3}{6} {γ}_{B \text{-} ran} + \frac{2}{6} {γ}_{A \text{-} ran}$ | $\frac{3}{6} {γ}_{B \text{-} ran} + \frac{2}{6} {γ}_{A \text{-} ran}$ |

For both B-striped and A-striped patterns, case 1 is favored if the following conditions are met:

γ_{A-C}<γ_{B-C} (Equation 6); and

γ_{B-C}−γ_{A-C}<γ_{A-B} (Equation 8)

or

γ_{B-C}<γ_{A-C} (Equation 4); and

γ_{A-C}−γ_{B-C}<γ_{A-B} (Equation 9)

Table 8 provides a summary of conditions for successful nX density multiplication under the assumptions described above.

| | | Chemical Pattern | |
|---|---|---|---|
| BCP thickness | | A stripe | B stripe |
| 1 | L₀ | $\begin{matrix}\begin{matrix}B wetting top \\ and\end{matrix} \\ {γ}_{A \text{-} C} - {γ}_{B \text{-} C} < \frac{1}{n} {γ}_{A \text{-} B}\end{matrix}$ | $\begin{matrix}\begin{matrix}A wetting top \\ and\end{matrix} \\ {γ}_{B \text{-} C} - {γ}_{A \text{-} C} < \frac{1}{n} {γ}_{A \text{-} B}\end{matrix}$ |
| 1.25 | L₀ | A wetting top and γ_{B-C} − γ_{A-C} < γ_{A-B} | |
| | | or | |
| | | B wetting top and γ_{A-C} − γ_{B-C} < γ_{A-B} | |
| 1.5 | L₀ | $\begin{matrix}\begin{matrix}A wetting top \\ and\end{matrix} \\ {γ}_{B \text{-} C} - {γ}_{A \text{-} C} < \frac{1}{n} {γ}_{A \text{-} B}\end{matrix}$ | $\begin{matrix}\begin{matrix}B wetting top \\ and\end{matrix} \\ {γ}_{A \text{-} C} - {γ}_{B \text{-} C} < \frac{1}{n} {γ}_{A \text{-} B}\end{matrix}$ |

The maximum density multiplication factor is given by the following condition

$$n < \frac{{γ}_{A - B}}{\vert {γ}_{B - C} - {γ}_{A - C} \vert} \qquad ( Equation 10 )$$

The above-described analysis can be performed for any BCP system by appropriately considering the interface at the patterned substrate, the interface at the top surface, and if different orientations are present in the film, the interface between the regions is also taken into account.

The following are examples of substrates, patterning techniques, patterns, top surfaces and block copolymer materials that may be used in accordance with certain embodiments.

### Substrate

Any type of substrate may be used. In semiconductor applications, wherein the block copolymer film is to be used as a resist mask for further processing, substrates such as silicon or gallium arsenide may be used. For patterned media applications, a master pattern for patterned media may be made on almost any substrate material, e.g., silicon, quartz, or glass.

According to various embodiments, the substrate may be provided with a thin film or imaging layer thereon. The imaging layer may be made of any type of material that can be patterned or selectively activated. In a certain embodiment, the imaging layer comprises a polymer brush or a self-assembled monolayer. Examples of self-assembled monolayers include self-assembled monolayers of silane or siloxane compounds, such as self-assembled monolayer of octadecyltrichlorosilane. In certain embodiments, the imaging layer or thin film to be patterned is a polymer brush layer. In certain embodiments, the polymer brush may include one or more homopolymers or copolymers of the monomers that make up the block copolymer material. For example, a polymer brush of at least one of styrene and methyl methylacrylate may be used where the block copolymer material is PS-b-PMMA. One example of a polymer brush to be used in a thin film is PSOH.

According to various embodiments, a pattern can include one or more chemistries preferential to one block of a BCP (or two or more blocks of a triblock or higher order BCP). For example, FIG. 3 provides a schematic illustration of a pattern including regions preferential to the A block of an A-b-B BCP and regions preferential to the B-block of a BCP. In some embodiments, a pattern includes a chemistry non-preferential to the blocks of the BCP. For example, FIG. 6 provides a schematic illustration of a pattern including regions preferential to the B block of an A-b-B BCP and regions non-preferential to the A and B blocks of the BCP.

Examples of preferential chemistries to a block of a BCP include homopolymers of the block. For example, a PS-OH brush may be used to provide a preferential chemistry for a PS block of a BCP. Examples of non-preferential chemistries for a BCP include random or statistical copolymers of the polymers of the BCP.

Substrates may be patterned by any method, including all chemical, topographical, optical, electrical, mechanical patterning and all other methods of selectively activating a substrate. A chemically patterned surface can include, for example, patterned polymer brushes or mats, including copolymers, mixtures of different copolymers, homopolymers, mixtures of different homopolmyers, block oligomers, and mixtures of different block oligomers. In embodiments where a substrate is provided with an imaging layer (such as a self-assembled monolayer or polymer brush layer) patterning the substrate may comprise patterning the imaging layer. Alternatively, a substrate may be patterned by selectively applying the pattern material to the substrate. In some embodiments, a resist can be patterned using an appropriate method. The substrate patterning include top-down patterning (e.g. lithography), bottom-up assembly (e.g. block copolymer self-assembly), or a combination of top-down and bottom-up techniques. In certain embodiments, the substrate is patterned with x-ray lithography, extreme ultraviolet (EUV) lithography or electron beam lithography. In certain embodiments, a chemically patterned surface can be prepared using a molecular transfer printing method as disclosed in US Patent Publication 2009/0260750, incorporated by reference herein. In certain embodiments, a chemically patterned surface can be prepared as described in Liu et al. “Fabrication of Lithographically Defined Chemically Patterned Polymer Brushes and Mats,” Macromolecules 2011 44 (7) pp 1876-1885, incorporated by reference herein.

### Substrate Pattern

Top and/or bottom surface patterns (as well as the block copolymer material used) affect self-assembled domains that result from the processes described above. The surface pattern(s) and the block copolymer film deposited on it are chosen to achieve the desired pattern in the block copolymer film. In certain embodiments, there is a 1:1 correspondence between the number of features patterned on the substrate (by e-beam lithography or other technique) and the number of features in the self-assembled block copolymer film. In other embodiments, there may be a 1:2, 1:4 or other correspondence, with the density of the substrate pattern multiplied as described in the above-referenced US Patent Publication 2009/0196488. It should be noted that in certain cases, the 1:1 correspondence (or 1:2, etc.) might not be exactly 1:1 but about 1:1, e.g., due to imperfections in the substrate pattern. The directed assembly may or may not be epitaxial according to various embodiments. That is, in certain embodiments, the features as defined by the block copolymer domains in the block copolymer film are located directly above the features in the chemical contrast pattern on the substrate. In other embodiments, however, the growth of the block copolymer film is not epitaxial. In these cases, the chemical contrast (or other substrate pattern) may be offset from the self-assembled domains.

In certain embodiments, the pattern corresponds to the geometry of the bulk copolymer material. For example, hexagonal arrays of cylinders are observed bulk morphologies of certain PS-b-PMMA and other block copolymers. However, in other embodiments, the substrate pattern and the bulk copolymer material do not share the same geometry. For example, a block copolymer film having domains of square arrays of cylinders may be assembled using a material that displays hexagonal arrays of cylinders in the bulk.

The individual features patterned on the substrate may be smaller than or larger than the mean feature size of the block copolymer domains (or the desired feature size). In certain embodiments, the Lₛ of the substrate pattern is about +/−0.1Lₒ. In some embodiments, a pattern may have a different length scale Ls than the bulk morphology, as discussed in Example 5, below. Examples include 1.5Lo or 2.0Lo. In certain embodiments, the pattern has at least one dimension within an order of magnitude of a dimension of one domain in the block copolymer material.

### Block Copolymer Material

The block copolymer material includes a block copolymer. The block copolymer can include any number of distinct block polymers (i.e. diblock copolymers, triblock copolymers, etc.). A specific example is the diblock copolymer PS-b-PMMA. Any type of copolymer that undergoes microphase separation under appropriate thermodynamic conditions may be used. This includes block copolymers that have as components glassy polymers such as PS and PMMA, which have relatively high glass transition temperatures, as well as more elastomeric polymers.

Classes of polymers that can be used as blocks of BCPs include silicon-containing polymers, metal-containing polymers, and polymers designed to have or low etch selectivities. Other examples of components of BCP blocks include polyethylene oxide (PEO), polydimethylsiloxane (PDMS), poly-2-vinylpyridine (P2PV), poly-4-vinylpyridine (P4PV), polylactic acid (PLA), polyglycolic acid (PGA), and polystyrene-polyferrocenyldimethylsilane. Examples of block copolymers include poly(styrene-b-ethylene oxide) (PS-b-PEO), poly(styrene-b-dimethylsiloxane) (PS-PDMS), and poly(styrene-b-2-vinylpyridine) (PS-b-P2VP).

The block copolymer material may include one or more additional block copolymers. In some embodiments, the material may be a block copolymer/block copolymer blend. An example of a block copolymer/block copolymer blend is PS-b-PMMA (50 kg/mol)/PS-b-PMMA (100 kg/mol).

In some embodiments, the block copolymer materials have interaction parameters (χ) greater than that of PS-PMMA. The interaction parameter χ is temperature-dependent; accordingly block copolymer materials having χ's greater than that of PS-PMMA at the temperature of assembly can be used in certain embodiments. In some embodiments, block copolymers having sub-10 nm domains in the bulk used.

The block copolymer material may also include one or more homopolymers. In some embodiments, the material may be a block copolymer/homopolymer blend or a block copolymer/homopolymer/homopolymer blend, such as a PS-b-PMMA/PS/PMMA blend.

The block copolymer material may include any swellable material. Examples of swellable materials include volatile and non-volatile solvents, plasticizers and supercritical fluids. In some embodiments, the block copolymer material contains nanoparticles dispersed throughout the material. The nanoparticles may be selectively removed.

The BCP film can be any appropriate thickness. In some embodiments, the film thickness is a multiple of the bulk length scale L₀ of the BCP. For example, the film thickness can be m×0.25×L₀, where m is an integer of at least 2.

### Top Surface

In the examples described above, a block copolymer material is directed to assemble between a chemically patterned surface and a second or top surface. In certain embodiments, the top surface may be chemically homogenous, while providing a boundary condition that allows perpendicular orientation of the domains of the BCP throughout the film surface. In certain embodiments, a chemically homogenous top surface may be a homopolymer, while providing a boundary condition that allows perpendicular orientation of the domains of the BCP throughout the film surface. In certain embodiments, the top surface may be preferential to one or more blocks of the BCP, while allowing perpendicular orientations of the BCP throughout the film surface.

A top surface can said to be preferential to one of the blocks of the BCP if there is a difference in interfacial energies between the top surface and each of two blocks of the BCP. For example, for an A-b-B BCP, a top surface C can said to be preferential to A if γ_{B-C}−γ_{A-C} is greater than 0. In the case of higher order block copolymers, a top surface C can be preferential to one or more blocks of the BCP. In some embodiments, the difference γ_{B-C}−γ_{A-C}, wherein C is a top surface and A and B are blocks of a BCP, can be greater than 0.1 mJ/cm³, 0.25 mJ/cm³, 0.5 mJ/cm³, 1.0 mJ/cm³, 2.0 mJ/cm³, or greater than 3.0 mJ/cm³ as long as the above conditions are met. In certain embodiments, a preferential surface may be a homopolymer. An interfacial energy may be determined experimentally and/or theoretically.

In some embodiments, a top surface can be characterized as a chemically homogeneous surface that meets the conditions described above in Equations 1-10 for perpendicular orientation throughout the thickness of the BCP film. In some embodiments, a top surface can be characterized as a homopolymer surface that meets the conditions described above for perpendicular orientation throughout the thickness of the BCP film. In some embodiments, a top surface can be a metal (or other conductive material) or a dielectric material that meets the conditions described above for perpendicular orientation throughout the thickness of the BCP film.

The top surface can be conformally deposited on the block copolymer material using a conformal deposition technique such as spin-on deposition, chemical vapor deposition, or atomic layer deposition. The top surface can be formed on a second substrate and brought into contact with the block copolymer material. For example, a polymer brush layer or mat can be deposited on a substrate. In some embodiments, an unsupported polymer film can be placed on the block copolymer material. In another example, a metal or a film on a carrier superstrate can be placed on the block copolymer material.

Although the foregoing invention has been described in some detail for purposes of clarity of understanding, it will be apparent that certain changes and modifications may be practiced within the scope of the invention. It should be noted that there are many alternative ways of implementing both the process and compositions of the present invention. Accordingly, the present embodiments are to be considered as illustrative and not restrictive, and the invention is not to be limited to the details given herein.

1. A method comprising:
providing a block copolymer material between a first surface chemically patterned with a pattern and a second surface, wherein the second surface is preferential to at least one block of the block copolymer material; and
directing the assembly of the block copolymer material in accordance with the pattern to form a thin film including microphase-separated block copolymer domains, wherein the microphase-separated block copolymer domains are oriented perpendicular to the first and second surfaces throughout the thickness of the thin film.

2. The method of claim 1, wherein the second surface is a homopolymer.

3. The method of claim 1, wherein the second surface is a metal.

4. The method of claim 1, wherein the second surface is a dielectric material.

5. The method of claim 1, wherein the pattern has a feature density less than that of the microphase-separated block copolymer domains.

6. The method of claim 5, wherein the pattern feature density is 1/n that of the density of microphase-separated block copolymer domains in the thin film, with n an integer equal to or greater than 2.

7. The method of claim 1, wherein the block copolymer material comprises a diblock copolymer.

8. The method of claim 1, wherein the block copolymer material comprises a triblock or higher order block copolymer.

9. The method of claim 1, wherein the block copolymer material comprises an A-b-B block copolymer, the second surface comprises a C homopolymer, the pattern feature density is 1/n that of the density of microphase-separated block copolymer domains in the thin film, and
$$n < \frac{{γ}_{A - B}}{\vert {γ}_{B - C} - {γ}_{A - C} \vert}$$
wherein γ_{B-C}, γ_{A-C}, and γ_{A-B} are the interfacial energies of the B-C, A-C and A-B polymers respectively.

10. The method of claim 1, wherein the block copolymer material comprises a lamellar-forming block copolymer.

11. The method of claim 1, wherein the block copolymer material comprises a cylindrical-forming or spherical-forming block copolymer.

12. A method comprising:
providing a A-b-B block copolymer between a first surface chemically patterned with a pattern and a C second surface; and
directing the assembly of the A-b-B block copolymer in accordance with the pattern to form a thin film including microphase-separated block copolymer domains, wherein the microphase-separated block copolymer domains are oriented perpendicular to the first and second surfaces throughout the thickness of the thin film, the pattern feature density is 1/n that of the density of microphase-separated block copolymer domains in the thin film, and
$$n < \frac{{γ}_{A - B}}{\vert {γ}_{B - C} - {γ}_{A - C} \vert}$$
wherein γ_{B-C}, γ_{A-C}, and γ_{A-B} are the interfacial energies of the B-C, A-C and A-B polymers respectively and n is greater than 1.

13. The method of claim 12, wherein the second surface is a homopolymer.

14. The method of claim 12, wherein the second surface is a metal.

15. The method of claim 12, wherein the second surface is a dielectric.

16. The method of claim 12, wherein n is equal to or greater than 2.

17. A structure comprising:
a block copolymer thin film between a first surface chemically patterned with a pattern and a second surface, wherein the second surface is preferential to at least one block of the block copolymer thin film, wherein the thin film comprises microphase-separated block copolymer domains oriented perpendicular to the first and second surfaces throughout the thickness of the thin film.

18. The structure of claim 17, wherein the second surface is a homopolymer.

19. The structure of claim 17, wherein the pattern has a feature density less than that of the microphase-separated block copolymer domains.

20. The structure of claim 17, wherein the pattern feature density is 1/n that of the density of microphase-separated block copolymer domains in the thin film, with n equal to or greater than 2.
